(19) United States
(12) Patent Application Publication
(10) Pub. No.: US 2021/0381985 A1
(43) Pub. Date: Dec. 9, 2021

(54) METHODS AND DEVICES FOR DETECTING A STIMULATED-RAMAN-SCATTERING (SRS) SIGNAL IN A SAMPLE

(71) Applicants: LIGHTCORE TECHNOLOGIES, Cannes (FR); Centre National de la Recherche Scientifique, Paris (FR); UNIVERSITÉ D'AIX MARSEILLE, Marseille (FR); Ecole Centrale de Marseille, Marseille (FR)

(72) Inventors: Hervé Rigneault, Allauch (FR); Sandro Heuke, Marseille (FR)

(73) Assignees: LIGHTCORE TECHNOLOGIES, Cannes (FR); Centre National de la Recherche Scientifique, Paris (FR); UNIVERSITÉ D'AIX MARSEILLE, Marseille (FR); Ecole Centrale de Marseille, Marseille (FR)

(21) Appl. No.: 17/339,444

(22) Filed: Jun. 4, 2021

(30) Foreign Application Priority Data
Jun. 5, 2020 (FR) 2005917

(51) Int. Cl. G01N 21/65; G01J 3/44

(52) U.S. Cl. CPC G01N 21/65; G01J 3/44; G01N 2201/06113; G01N 2201/12; G01N 2021/655

(57) ABSTRACT

According to one aspect, the present description relates to a device for detecting an SRS resonant non-linear optical signal induced in a sample. The device comprises a light source configured for emitting a first train of pump pulses at a first angular frequency and a second train of Stokes pulses at a Stokes second angular frequency, and first and second amplitude modulators configured to amplitude modulate the train of pump pulses at a first modulation frequency and the train of Stokes pulses at a second modulation frequency different from the first modulation frequency, respectively. The device further comprises optomechanical means for making interact in the sample said amplitude-modulated trains of pump and Stokes pulses, means for optical detection of first and second non-linear optical signals at the first angular frequency and second angular frequency, respectively, and means of synchronous detection of the first and second optical signals at said second modulation frequency and at the first modulation frequency, respectively, allowing an SRL first signal and an SRG second signal that are characteristic of the molecular vibrational resonance of the sample to be extracted.

### TECHNICAL FIELD OF THE INVENTION

The present description relates to devices and methods for detecting a resonant non-linear optical signal of stimulated-Raman-scattering (SRS) type in a sample. It is especially applicable to microscopic imaging, to spectroscopy and to hyperspectral imaging in scattering media such as biological media.

### PRIOR ART

Chemical bonds all possess vibrational frequencies that are specific. Methods that aim to use the interaction of light/matter to obtain information on these molecular vibrations are called vibrational optical techniques. The best-known of these techniques is infrared (IR) spectroscopy, which observes the specific absorption lines of the chemical bonds present in a sample. Discovered in 1928, Raman scattering (named after the physicist Chandrasekhara Venkata Raman who discovered the effect) allows visible light to be used to access the vibrational spectrum of molecules that interact with a light beam. In a Raman-scattering process, a pump wave of angular frequency ω_{P} incident on a molecule is inelastically scattered into a wave called the Stokes wave, of angular frequency ω_{S}, and a wave, called the anti-Stokes wave, of angular frequency ω_{AS}. The frequency difference between the generated waves and the pump wave depends on the molecular Raman transition (of angular frequency Ω_{R}) such that ω_{P}−ω_{AS}=−ω_{P}=Ω_{R}. Considering the process from a photonic point of view, the Stokes and anti-Stokes waves correspond to an absorption from the excited or ground vibrational level, respectively. The process that generates the anti-Stokes wave, which starts from the excited vibrational level, is much less probable than the process that creates the Stokes wave, which is the only one observed in practice in spontaneous Raman spectroscopy. A close study of the spectral distribution of the Stokes waves provides information on the densities of chemical bonds present in the sample. This spontaneous inelastic-scattering process is very unlikely compared to fluorescence (Raman cross sections are of the order of 10⁻³⁰ cm² /molecule, which is to be compared with the cross section of one-photon absorption of a fluorophore which may be as high as 10⁻¹⁶ cm²/molecule).

The stimulated Raman techniques CARS (for Coherent Anti-Stokes Raman Scattering) and SRS (for Stimulated Raman Scattering) are coherent Raman scattering processes that yield, with respect to the spontaneous Raman scattering process, a gain of about 10⁷. In these techniques (see FIG. 1A), two laser pulses of angular frequencies Ωₚ and Ωₛ (or frequencies νₚ and νₛ), the difference in the angular frequencies of which is set equal to the angular frequency Ω_{R} of the vibrational level that it is desired to address, are transmitted into the medium to be analysed. These pulses, which are denoted the pump and Stokes pulses, respectively, create a beat frequency that causes the vibrational mode of angular frequency Ω_{R} to resonate. In the degenerate CARS process, this resonance is probed by the pump beam that induces the anti-Stokes scattering at the angular frequency ω_{AS}.

Stimulated Raman scattering (SRS) is a process that results from the enhancement of the non-linear response due to the interaction of the non-linear field induced by the pump and Stokes fields with the exciting (pump) field and is therefore observed, contrary to the CARS process, at the same frequencies as the pump and Stokes pulses. It results in a transfer of energy from the pump beam to the Stokes beam. Thus, as illustrated in FIG. 1B, stimulated Raman scattering covers two processes, the SRL process (SRL being the abbreviation of Stimulated Raman Loss) and the SRG process (SRG being the abbreviation of Stimulated Raman Gain), which induce a loss of intensity ΔIs_{RL} in the pump beam and a gain in intensity ΔI_{SRG} in the Stokes beam, respectively. The SRS process is for example described in the review article by N. Bloembergen et al. [Ref. 1]. It has been shown that the intensity loss ΔI_{SRL} of the pump beam and the intensity gain ΔI_{SRG} of the Stokes beam are proportional to the imaginary part of the non-linear susceptibility of order 3(Im(χ_{R}⁽³⁾)). Measurement of these quantities therefore allows the Raman spectrum to be rigorously determined. Recently, vibrational optical techniques have concentrated more on SRS techniques, which are linear with the concentration of the chemical species, contrary to CARS techniques; moreover, SRS techniques are not subject to a non-resonant background always present in CARS.

SRS microscopy is a recent technique that has taken advantage of recent advances in the field of femtosecond SRS spectroscopy. However, an SRS microscope based on an amplified laser system delivering femtosecond pulses induces a strong SRS signal but is not suitable for biological imaging. Specifically, the high peak powers involved (of the order of a few hundred nJ or even of one μJ) damage the samples, and the low repetition rates (1 kHz) are incompatible with rapid scanning microscopy.

It has thus been proposed (see for example the article by C. W. Freudiger et al. [Ref. 2]) an SRS microscope based on the use of a high-repetition-rate (80MHz) picosecond laser system compatible with the formation of images of biological samples. In CARS microscopy, the useful signal, i.e. the anti-Stokes signal, is generated at a different frequency from the exciting beams. Said signal may be detected by extremely sensitive detectors such as avalanche photodiodes or photomultiplier tubes. In SRS microscopy, the detection context is different because the useful signal is generated at the same frequency as the exciting beams. It is then a question of detecting the energy loss ΔI_{SRL} of the pump beam or, equally, the energy gain ΔI_{SRG} of the Stokes beam. In practice, the energy loss ΔI_{SRL}/I_{P} of the pump beam is comprised between 10⁻⁵ and 10⁻⁸. In the aforementioned article, it is proposed to modulate the Stokes signal at a given frequency and to extract the loss of the pump signal at said frequency via lock-in detection, in order to increase detection sensitivity.

FIG. 1C thus shows a schematic of a prior-art SRS microscope in SRG configuration, i.e. in a configuration suitable for extracting the gain of the Stokes beam. Trains, referenced 102 and 104 in FIG. 1C, of pump and Stokes pulses at the angular frequencies ωₚ and ω_{S}, respectively, are transmitted to a sample S positioned at the focal point of a microscope objective 122 placed in the body of a microscope 120. The angular frequencies ωₚ and ω_{S} are chosen such that the difference between the angular frequencies is equal to an angular frequency Ω_{R} of the vibrational level that it is desired to address in the sample. The trains of pump and Stokes pulses are spatially superposed by means of a combiner 114 and an adjustable delay line (not shown) is provided in order to ensure the temporal superposition of the pulses in the sample. The train of pump pulses 102 is amplitude modulated at the modulation frequency fₘ by means of a modulating device 112 so as to form a modulated train of pulses 106. In order to decrease electronic noise and the noise of the laser, the chosen modulation frequency is higher than 1 MHz. In FIG. 1C, the curves 101 and 103 thus show the time-domain envelope of the light intensities I_{P} and I_{S} of the modulated train of pump pulses 106 and of the (unmodulated) train of Stokes pulses 104, respectively. A collecting objective 124 allows the optical signals resulting from the interaction of the pump and Stokes pulses in the sample to be collected. In the chosen configuration, a filter 126 allows the train 108 of pulses at the angular frequency cos to be selected, which train of pulses is then transmitted to an optical detector 128, a photodiode for example. The optical intensity measured as a function of time is schematically shown by the curve 107. Synchronous detection 130 at the modulation frequency fₘ allows the sought-after signal ΔI_{SRG}, which is characteristic of the molecular vibration at the angular frequency Ω_{R}, to be extracted. Scanning the exciting beams 104, 106 in the sample, for example by means of a scanning system 116 comprising two galvanometric mirrors, then allows an image of the region of interest of the sample to be formed.

SRS microscopy is however subject to a certain number of artefacts that limit chemical specificity because they introduce signals that may be interpreted as the SRS signal. In particular, SRS microscopy is sensitive to cross phase modulation (XPM), which is not specific to the targeted chemical bonds and appears as a positive or negative offset in the SRS signal. SRS microscopy is also sensitive to two-photon absorption (TPA), which appears as a positive offset (in SRL configuration) or a negative offset (in SRG configuration) in the SRS signal. The paper by T. Bremer et al [Ref. 3] describes a device for the detection of a resonant non-linear Raman Scattering signal induced in a sample that allows avoiding artefacts. In the method described in [Ref.3], femtosecond pulses are sent at a low rate (1 KHz) and each pulse is shaped to generate two pulses with the same energy and spectral profile (same angular frequency) but with a time shift. The first pulse is sent directly to the sample while the second pulse passes through a window that generates a temporal dispersion of the pulse. When the first pulse is focused on the sample, due to the temporal sharpness and spectral width of the first pulse, a spectrally red-shifted non-linear backscattered signal is generated by stimulated Raman scattering (SRS). The detection of the spectral components of the non-linear signal by means of two detectors separated by a dichroic mirror allows the acquisition of two images SRG and SRL. Due to the time dispersion, the second pulse sent to the sample does not generate a non-linear SRS signal. The backscattered signal resulting from the interaction of the second pulse in the sample can therefore be used as a reference and is subtracted from the non-linear backscattered signal resulting from the interaction of the first pulse in the sample. Due to the mechanism employed in [Ref.3], namely the generation of an SRS signal by the first broadband pulse alone, the method in [Ref.3] is limited in the number of vibrational frequencies (or resonance frequencies) that can be detected and is otherwise unable to detect vibrational frequencies above 1000 cm⁻¹.

In the published patent application WO2014154708 [Ref. 4], a device is described that employs three exciting beams, at three pre-set angular frequencies ω₁, ω₂ and ω₃, the interactions of which pairwise in the sample at the first frequency and second frequency of modulation allow both an SRL process and an SRG process to be generated, the beam of intermediate angular frequency (ω₂) serving alternatively as pump beam or as Stokes beam in each of the processes. For example, the trains of pulses at the angular frequencies ω₁ and ω₃ are amplitude modulated at the same modulation frequency but in phase opposition. Lock-in detection at the one or more modulation frequencies of the non-linear optical signals resulting from the interactions of the two processes allows artefacts to be at least partially avoided and the useful SRS signal to be multiplied by two.

Although this device, because of the at least partial suppression of artefacts, allows the quality of the useful SRS signal obtained to be substantially improved with respect to known prior-art devices, it requires three exciting beams at three different angular frequencies ω₁, ω₂ and ω₃, thus increasing the bulk and complexity of the optical device.

The present description proposes an alternative method for detecting a resonant non-linear optical signal of SRS type induced in a sample, which allows artefacts in an SRS signal to be detected and, optionally, a useful SRS signal freed at least partially from artefacts to be produced, as in the method described in [Ref. 4], but while preserving a device with only two exciting beams.

### SUMMARY OF THE INVENTION

In the present description, the term “comprise” means the same thing as “include” or “contain”, and is inclusive or open and does not exclude other elements that are not described or shown.

Furthermore, in the present description, the term “about” or “substantially” is synonymous with (means the same thing as) a margin higher and/or lower by 10%, and for example 5%, than the respective value.

According to a first aspect, the invention relates to a device for detecting a resonant non-linear optical signal of stimulated-Raman-scattering type induced in a sample, the device comprising:
a light source configured for emitting a first train of pump pulses at a first angular frequency and a second train of Stokes pulses at a second angular frequency, the angular frequencies being such that a difference between the first and second angular frequencies is equal to an angular frequency of molecular vibrational resonance of the sample, the first and second trains of pulses being temporally synchronized;
a first amplitude modulator configured to amplitude modulate the first train of pump pulses at a first modulation frequency and a second amplitude modulator configured to amplitude modulate the second train of Stokes pulses at a second modulation frequency different from the first modulation frequency;
optomechanical means for making interact in the sample said amplitude-modulated trains of pump and Stokes pulses;
first optical detecting means configured for optical detection of a first non-linear optical signal at said first angular frequency, said first non-linear optical signal resulting from the interaction of the light pulses in the sample, and means of synchronous detection at said second modulation frequency, allowing a first signal characteristic of the molecular vibrational resonance of the sample to be extracted from the first non-linear optical signal thus detected;
second optical detecting means configured for optical detection of a second non-linear optical signal at said second angular frequency, said second non-linear optical signal resulting from the interaction of the light pulses in the sample, and means of synchronous detection at said first modulation frequency, allowing a second signal characteristic of the molecular vibrational resonance of the sample to be extracted from the second non-linear optical signal thus detected;
electronic processing means configured to compare said first and second signals characteristic of the molecular vibrational resonance of the sample in order to determine the presence of artefacts.

In practice, the first signal characteristic of the molecular vibrational resonance of the sample is generated by an SRL process since it is measured at the angular frequency of the pump pulses. It corresponds to the decrease in the intensity of the pump pulses and will be denoted more simply in the rest of the description the “SRL signal”. The second signal characteristic of the molecular vibrational resonance of the sample is generated by an SRG process since it is measured at the angular frequency of the Stokes pulses. It corresponds to the increase in the intensity of the Stokes pulses and will be denoted more simply in the rest of the description the “SRG signal”.

This new device thus allows, with only two exciting (pump and Stokes) beams respectively formed from trains of pulses at two angular frequencies that are pre-set depending on the molecular vibrational resonance of the sample that it is sought to study, the presence or not of artefacts in the measurement of the SRL and SRG signals characteristic of said molecular vibrational resonance to be determined. Specifically, by virtue of the amplitude modulation at various frequencies of the trains of pump and Stokes pulses, it is possible, with a suitable detection, to obtain the SRL and SRG signals directly. Since these signals are normally both proportional to the imaginary part of the non-linear susceptibility of order 3(Im(χ_{R}⁽³⁾)), they should be identical to within a constant of proportionality, and their comparison allows artefacts to be detected.

According to one or more exemplary embodiments, said modulation frequencies are radio frequencies, for example comprised between about 1 MHz and about 40 MHz.

According to one or more exemplary embodiments, said modulation frequencies are not multiples of each other. This configuration makes it possible to avoid, even when the amplitude modulators generate harmonics of the first and/or second frequency, generation of pump and Stokes beams at the same frequencies.

In practice, the first frequency and the second frequency will possibly be chosen such as to prevent any interference with other radio frequencies of electronic apparatuses of the device.

In one or more exemplary embodiments, the optomechanical means for making the trains of pulses interact in the sample comprise an optical element for focusing the trains of pulses into a common focal volume, a microscope objective for example, allowing sufficient energy densities to be obtained in the sample to generate the non-linear optical effects.

According to one or more exemplary embodiments, the device further comprises a splitting element configured to split the first and second optical signals resulting from the interaction of the light pulses in the sample, at the first and second angular frequencies, respectively.

According to one or more exemplary embodiments, the splitting element allows the first and second optical signals to be split spectrally and for example comprises an optical element such as, for example, a dichroic plate, a prism or a diffraction grating, allowing a spatial wavelength dispersion to be obtained.

According to one or more exemplary embodiments, the device is at least partially fibre-based. The applicant has shown that the implemented detecting method further allows artefacts due to the non-linear effects generated in the fibre to be detected.

According to one or more exemplary embodiments, the device according to the first aspect is configured to be used in Raman vibrational imaging, and for example in microscopic imaging. The optomechanical means for making interact in the sample said trains of pump and Stokes pulses may then comprise means for moving relatively the focal volume in the sample so as to enable imaging to be carried out.

According to one or more exemplary embodiments, the device according to the first aspect is configured to be used in Raman spectroscopy. The device may for example comprise means for varying the angular frequencies of the trains of pump and/or Stokes pulses that interact in the sample, making it possible to make vary the angular frequency of molecular vibrational resonance of the sample that it is sought to study.

According to one or more exemplary embodiments, the device according to the first aspect is configured to be used in Raman hyperspectral imaging, allowing SRS images of the sample to be produced at various angular frequencies of molecular vibrational resonance.

According to one or more exemplary embodiments, the first and second optical detecting means are configured for optical detection in a forward detection mode.

According to one or more exemplary embodiments, the first and second optical detecting means are configured for optical detection in an epi detection mode. The “epi” mode is advantageous especially for thick/or weakly transparent samples.

According to one or more exemplary embodiments, the device is configured to operate as an endoscope. The optical detection is then in “epi” mode and the device further comprises an optical fibre for the transport of the trains of pump and Stokes pulses to the sample to be studied and the transport of the optical signals resulting from the non-linear interaction to first and second detectors of the first and second detecting means, respectively.

According to one or more exemplary embodiments, the first and second means of synchronous detection each comprise an analogue or digital lock-in detection.

According to one or more exemplary embodiments, the device further comprises at least one delay line located on the path of one of the first and second trains of pulses, said delay line being configured to introduce a time delay between the first and second trains of pulses. A delay line makes it possible to ensure that the pump and Stokes pulses reach the sample at the same time, thus making the non-linear interaction possible.

According to one or more exemplary embodiments, the time delay is variable.

According to one or more exemplary embodiments, the pulses of the first and/or of the second trains of pulses are pulses of durations comprised between about 1 ps and about 10 ps, and for example between about 1 ps and about 3 ps. Such pulses are spectrally narrow, centred on the first and second angular frequencies, respectively, and have a spectral width comprised between about 15 cm⁻¹ and about 5 cm⁻¹. For example, the light source comprises a picosecond laser source comprising a master laser that emits the trains of pump pulses with the first angular frequency and an optical parametric oscillator (OPO) configured to produce, from the pump pulses emitted by the master laser, the trains of Stokes pulses of second angular frequency. This arrangement has the advantage that the trains of pump and Stokes pulses are automatically synchronized. Moreover, it is possible to modify the angular frequency of the Stokes pulses since the OPO is tunable.

According to another example, the light source comprises a master laser and two OPOs, the two OPOs being configured to generate the trains of pump and Stokes pulses from pulses emitted by the master laser. The trains of pulses are once again automatically synchronized, and it is possible to modify the angular frequency of the pump pulses and of the Stokes pulses since the OPOs are tunable.

According to another example, the light source comprises two synchronized lasers that generate the trains of pump and Stokes pulses, for example an ytterbium laser and an erbium laser. In this case, the difference in the angular frequency is set between the trains of pump and Stokes pulses.

According to one or more exemplary embodiments, the pulses of the first and/or of the second train of pulses are frequency-chirped pulses centred on the first and second angular frequencies, respectively.

For example, the light source comprises a femtosecond laser source comprising a master laser that emits the trains of pump pulses with the first angular frequency, an optical parametric oscillator (OPO) configured to produce, from the pump pulses emitted by the master laser, the trains of Stokes pulses of second angular frequency, and a temporal stretcher configured to stretch the pump and/or Stokes pulses temporally. According to one or more exemplary embodiments, the temporal stretcher comprises a prism-based dispersion line, a grating-based dispersion line, or a simple glass bar configured to disperse the fs pulses.

As above, the light source may also comprise a master laser and two OPOs or two synchronized lasers.

According to one or more exemplary embodiments, in the case of frequency-chirped pulses, the device may further comprise a delay line allowing a time shift to be generated between the pulses of the first and second trains of pulses, variation of the time shift allowing various angular frequencies of molecular vibrational resonance of the sample to be probed.

According to a second aspect, the invention relates to a method for detecting a resonant non-linear optical signal of stimulated-Raman-scattering (SRS) type induced in a sample, implemented by the described device according to the first aspect and all of the variants or exemplary embodiments thereof.

According to one or more exemplary embodiments, the method according to the second aspect comprises:
the emission of a first train of pump pulses at a first angular frequency and a second train of Stokes pulses at a second angular frequency, the angular frequencies being such that a difference between the first and second angular frequencies is equal to an angular frequency of molecular vibrational resonance of the sample, the first and second trains of pulses being temporally synchronized;
the amplitude modulation of said first train of pump pulses and said second train of Stokes pulses at a first modulation frequency and at a second modulation frequency different from the first modulation frequency, respectively;
the interaction in the sample of said amplitude-modulated trains of pump and Stokes pulses;
a first optical detection of a first non-linear optical signal at said first angular frequency, said first optical non-linear signal resulting from the interaction of the light pulses in the sample, and a first synchronous detection at said second modulation frequency, allowing a first signal characteristic of the molecular vibrational resonance of the sample to be extracted from the first non-linear optical signal thus detected;
a second optical detection of a second non-linear optical signal at said second angular frequency, said second non-linear optical signal resulting from the interaction of the light pulses in the sample, and a second synchronous detection at said first modulation frequency, allowing a second signal characteristic of the molecular vibrational resonance of the sample to be extracted from the second non-linear optical signal thus detected;
a comparison of said first and second signals characteristic of the molecular vibrational resonance of the sample in order to determine the presence of artefacts.

According to one or more exemplary embodiments, the interaction in the sample of said amplitude-modulated trains of pump and Stokes pulses comprises focusing the trains of pulses into a common focal volume, a microscope objective for example, allowing sufficient energy densities to be obtained in the sample to generate the non-linear optical effects.

According to one or more exemplary embodiments, said method for detecting a resonant non-linear optical signal of SRS type is a Raman-vibrational-imaging method, for example a microscopic-imaging method, said method further comprising a relative movement of the focal volume in the sample.

According to one or more exemplary embodiments, said comparison of said first and second signals characteristic of the molecular vibrational resonance of the sample comprises the computation of a ratio between said two, SRL and SRG, signals.

In practice, the method may comprise a prior calibrating step that is for example carried out with a test sample, such that the expected ratio is equal to a pre-set constant, to 1 for example. In this case, a ratio different from said pre-set constant indicates an asymmetric SRS effect in SRL and SRG, revealing the presence of artefacts.

When the method is an imaging method, the computation of a ratio between said two, SRL and SRG, signals, which are in this case two-dimensional signals, allows variations within the image that reveal the local presence of artefacts to be determined. For example, said comparison comprises the prior computation of the spatial average of each of the SRL and SRG signals, the normalization of each signal by said mean and the computation of the ratio. The computation of the ratio in this case allows differential artefacts between the SRL and SRG signals to be revealed.

According to one or more exemplary embodiments, the method further comprises the computation of a sum of said two signals characteristic of the molecular vibrational resonance of the sample, the resultant signal being at least partially freed from said artefacts. The applicant has shown that summing the SRL and SRG signals at least partially cancels out artefacts, and more precisely symmetric artefacts that make a positive contribution to the SRL signal and a negative contribution to the SRG signal (or vice versa). Moreover, the sum will double the SRS signal by adding the SRL signal to the SRG signal.

According to one or more exemplary embodiments, the method further comprises computing a difference of said two signals characteristic of the molecular vibrational resonance of the sample. It is then possible to identify symmetric artefacts.

As above, the computation of the sum (or of the difference) may be carried out after calibration or, in the case of an imaging method, on the basis of SRL and SRG signals normalized by a mean determined beforehand from the entirety of each signal.

According to one or more exemplary embodiments, the first and second trains of pulses are trains of frequency-chirped pulses centred on the first and second angular frequencies, respectively.

According to one or more exemplary embodiments, the method further comprises the generation of a time shift between the pulses of the first train of pulses and the pulses of the second train of pulses, such as to make vary the frequency of molecular vibrational resonance of the sample at which the non-linear optical signal is detected.

### BRIEF DESCRIPTION OF THE FIGURES

Other advantages and features of the invention will become apparent on reading the description, which is illustrated by the following figures:

FIG. 1A, which has already been described, shows a simplified schematic illustrating the principle of stimulated Raman scattering (SRS);

FIG. 1B, which has already been described, shows a simplified schematic illustrating the SRL and SRG processes;

FIG. 1C, which has already been described, shows a schematic of an example of an SRS microscope according to the prior art;

FIG. 2 shows a schematic of an example of an SRS microscope according to the present description;

FIG. 3A shows a schematic illustrating the temporal modulation at the first frequency and the frequency spectrum of a train of pump pulses in one example of implementation of a method according to the present description;

FIG. 3B illustrates the temporal modulation at the second frequency and the frequency spectrum of a train of Stokes pulses in one example of implementation of a method according to the present description;

FIG. 3C illustrates the temporal modulation and the frequency spectrum of an SRL signal detected at the pump wavelength, in one example of implementation of a method according to the present description;

FIG. 3D illustrates the temporal modulation and the frequency spectrum of an SRG signal detected at the Stokes wavelength, in one example of implementation of a method according to the present description;

FIG. 4A illustrates, via schematics, the detection at the second frequency and at the pump wavelength of the optical signal resulting from the non-linear interaction, in steps of an example of a method according to the present description;

FIG. 4B illustrates, via schematics, the detection at the first frequency and at the Stokes wavelength of the optical signal resulting from the non-linear interaction, in steps of an example of a method according to the present description;

FIG. 5A shows experimental SRL, SRG and SRL/SRG images of the surface of an oyster shell, which images were obtained with an SRS microscope according to the present description, at the resonant frequency of phosphate (1090 cm⁻¹);

FIG. 5B shows experimental SRL, SRG and SRL/SRG images of mouse nerve cells, which images were obtained with an SRS microscope according to the present description, at the resonant frequency of the CH₂ bond (2850 cm⁻¹);

FIG. 6 shows experimental SRL, SRG and SRL+SRG images and experimental images of the signal-to-noise ratios of SRL, SRG and SRL+SRG of the surface of an onion cell, which images were obtained with an SRS microscope according to the present description, off resonance, at the resonant frequency of the CH₂ bond (2850 cm⁻¹);

FIG. 7 shows a schematic of another example of an SRS microscope according to the present description, in an endoscopic mode using an optical fibre;

FIG. 8 shows schematics illustrating pump and Stokes pulses, after they have been frequency chirped, for two time-delay values separated by Δt.

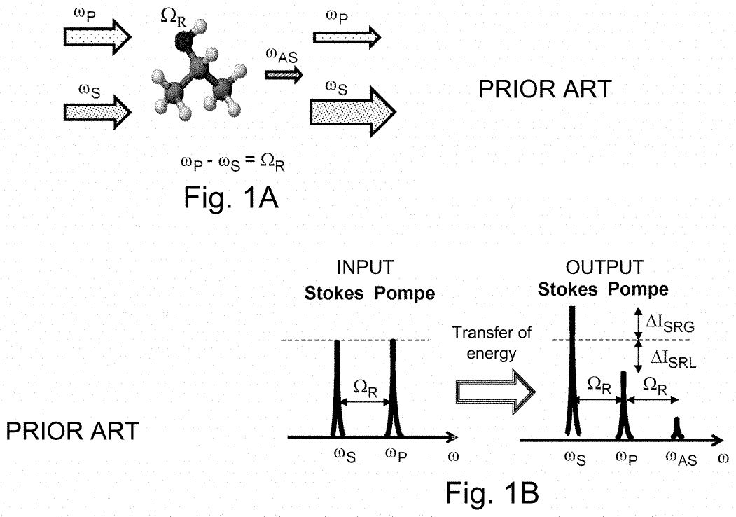

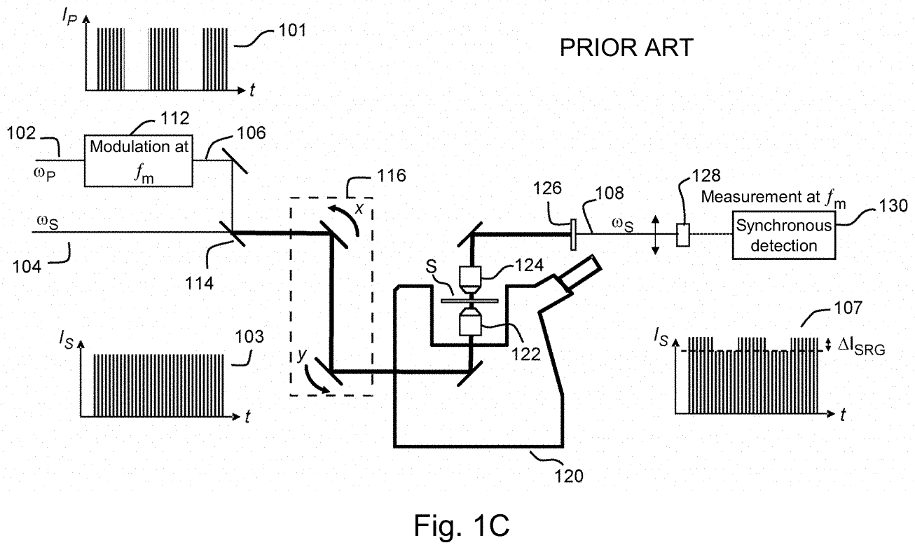

### DETAILED DESCRIPTION OF THE INVENTION

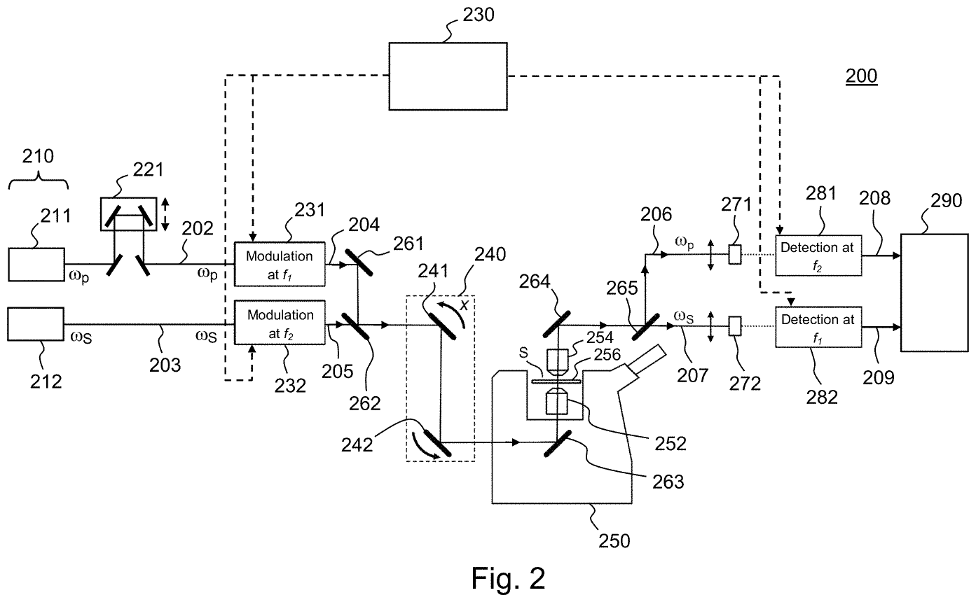

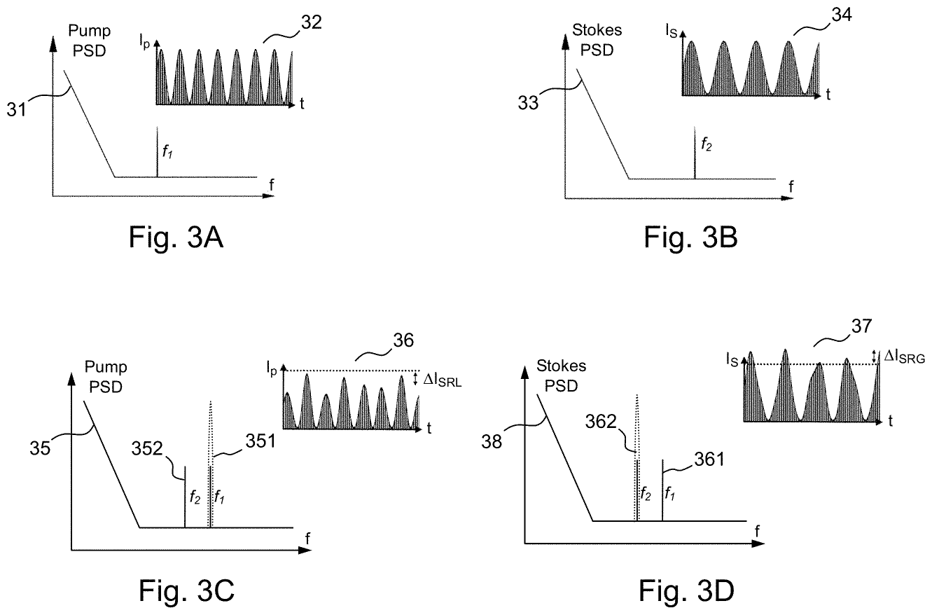

In the figures, the elements have not been shown to scale in order to be more easily seen. FIG. 2 shows a simplified schematic illustrating an example of a device 200 for detecting a resonant non-linear optical signal of stimulated-Raman-scattering (SRS) type induced in a sample S, and more precisely a schematic illustrating an example of an SRS microscope according to the present description. FIGS. 3A-3D show schematics illustrating the optical intensity as a function of time of trains of pulses at the pump and Stokes angular frequencies during the method and schematics showing the frequency spectrum of said trains of pulses.

The device 200 comprises a light source 210 that is configured to emit a first beam 202, or “pump beam”, formed from a first train of pump pulses at a first angular frequency ωₚ and that is configured to emit a second beam 203, or “Stokes beam” formed from a second train of Stokes pulses at a second angular frequency ωₛ, these angular frequencies being such that a difference ωₚ−ωₛ between the first and second angular frequencies is equal to an angular frequency Ω_{R} of molecular vibrational resonance of the sample S that it is sought to observe.

The first train of pulses and the second train of pulses are synchronized temporally in order to allow the interaction of the pump and Stokes pulses in the sample.

The pulses are for example picosecond pulses, of durations comprised between about 1 ps and about 10 ps and for example between about 1 ps and about 3 ps, and of spectral width comprised between about 15 cm⁻¹ and about 5 cm⁻¹, or may be frequency-chirped pulses as will be described in more detail below. Typically, the pulses are emitted at rates of a few tens of MHz and comprised for example between about 10 MHz and about 100 MHz and for example about 80 MHz, for a duration of about 1 μs.

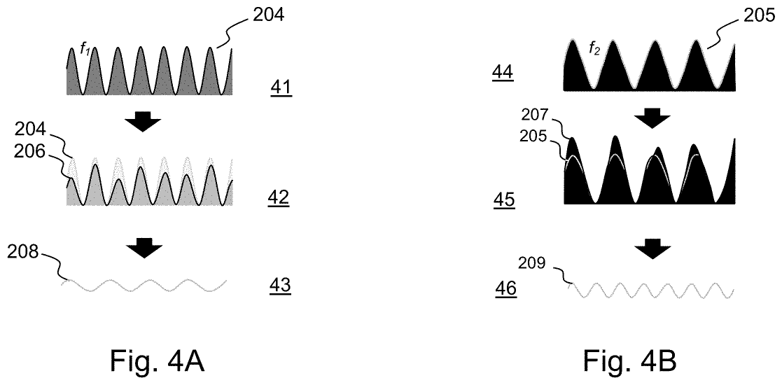

The light source 210 may comprise synchronized independent lasers 211, 212, as shown in FIG. 4.

In other exemplary embodiments, the light source 210 may comprise a laser system with a master laser that emits trains of pulses at the pump angular frequency and a laser OPO (or optical parametric oscillator) that receives from the master laser the pump pulses and that is configured to emit pulses at the Stokes angular frequency. The light source 210 may also comprise a laser system with a master laser and two OPOs configured to generate the trains of pump and Stokes pulses from pulses emitted by the master laser. In both cases, the trains of pulses are automatically synchronized. It is moreover possible to modify the angular frequency of the Stokes pulses, and optionally of the pump pulses in the case of two OPOs since OPOs are wavelength tunable.

For example, in the case of a laser system consisting of a master laser and of an OPO, the master laser may emit pump pulses with a pump angular frequency corresponding to a wavelength comprised between about 1000 nm and about 1100 nm and for example between about 1030 nm and about 1065 nm, this wavelength range covering the wavelengths of emission of an ytterbium laser and of a YAG laser. The OPO may emit Stokes pulses with a Stokes angular frequency corresponding to a wavelength comprised between about 600 nm and about 1000 nm and for example between about 640 nm and about 960 nm.

In the case of a laser system comprising a master laser and two OPOs, the master laser may emit pulses with an angular frequency corresponding to a wavelength comprised, as above, between about 1000 nm and about 1100 nm and for example between about 1030 nm and about 1065 nm, and the OPOs may each emit pump and Stokes pulses with angular frequencies corresponding to wavelengths comprised between about 600 nm and about 1000 nm and for example between about 640 nm and about 960 nm. In the example of FIG. 2, a delay line 221 allows the trains of pump and Stokes pulses to be synchronized temporally in order to ensure a temporal overlap of the pulses in the sample.

As will be described in more detail below, the delay line may be configured to introduce a variable time delay. It may be positioned on either or both of the pump and Stokes channels.

Moreover, the device 200 comprises a first amplitude modulator 231 configured to amplitude modulate the first train of pump pulses at a first modulation frequency f₁ and a second amplitude modulator 232 configured to amplitude modulate the second train of Stokes pulses at a second modulation frequency f₂ different from the first modulation frequency. As a result, pump and Stokes beams formed from pulse trains that are amplitude modulated at the frequencies f₁ and f₂, and that are denoted 204 and 205 in FIG. 2, respectively, are produced.

FIG. 3A thus illustrates, according to one example, the intensity Iₚ of a train of pulses 204 at the pump angular frequency ωₚ, which train is amplitude modulated at the frequency f₁ (curve 32). Curve 31 in FIG. 3A illustrates the power spectral density (PSD) as a function of frequency for the train of pulses 204. As may be seen in FIG. 3A, the frequency spectrum comprises, at low frequencies, a 1/f contribution related to noise, and the contribution at f₁. It will be noted that the frequency peak at the repetition frequency of the pulses has not been shown in the figure.

In the same way, FIG. 3B illustrates, according to one example, the intensity I_{S} of a train of pulses 205 at the pump angular frequency ωₚ, which train is amplitude modulated at the frequency f₂ (curve 34). Curve 33 in FIG. 3A illustrates, as above, the power spectral density as a function of frequency for the train of pulses 205 with, in particular, the peak at the frequency f₂ corresponding to the modulation of the train of pulses. The amplitude modulators 231, 232 are for example acousto- or electro-optical modulators that receive modulation signals from a radiofrequency (RF) generator 230. The modulation frequencies f₁ and f₂ are for example comprised between 1 MHz and 40 MHz.

Advantageously, they are selected so as not to be multiples of one another in order to avoid, when the amplitude modulators are not perfect and generate harmonics, generating pump and Stokes beams at the same frequencies.

In the example of FIG. 2, the device 200 further comprises optomechanical means for making interact in the sample S said amplitude-modulated trains of pump and Stokes pulses 204, 205. The optomechanical means comprise, in this example, reflective elements 261, 262, 263, which for example include a dichroic mirror 262, and a microscope objective 252 that is configured to focus the pump and Stokes pulses into a common focal volume in the sample S. The microscope objective 252 and the steering mirror 263 are, in this example, arranged in the body of a microscope 250. The microscope objective is for example a microscope objective of numerical aperture comprised between about 0.3 and about 1.3 and for example of a numerical aperture NA=0.5. The microscope objective is moreover advantageously achromatic in the wavelength domain of interest, for example in the near infrared (600-1100 nm).

According to exemplary embodiments, the optomechanical means may also comprise, on each of the pump and Stokes channels, a telescope (not shown) of given magnification, allowing the divergence of the pump and Stokes beams to be adjusted in order to optimize their spatial overlap at the focal point of the microscope objective. For example, the pump and Stokes beams are excited in their fundamental TEMOO mode so that the electric and magnetic fields are both perpendicular to the direction of propagation of these signals; the pump and Stokes beams are for example linearly polarized with the same polarization direction, allowing the signal to be optimized in a homogenous medium.

The optomechanical means may also comprise a motorized stage 256 allowing the sample S to be moved relative to the common focal volume of the trains of pulses, in order to form an image of the sample for an application of the device to SRS imaging. Alternatively, or in addition, a system 244 scanning the pump and Stokes beams, for example comprising two galvanometric mirrors 241, 242, may also be used to move the focal volume in the sample.

The device 200 moreover comprises first optical detecting means configured for optical detection, at the pump angular frequency ωₚ, of a first non-linear optical signal 206 resulting from the interaction of the light pulses in the sample.

FIG. 3C illustrates, according to one example, the intensity Iₚ of the first non-linear optical signal 206 at the pump angular frequency Wₚ (curve 36), and curve 35 in FIG. 3C illustrates the power spectral density as a function of frequency for the optical signal 206. As may be seen in FIG. 3C, in addition to the modulation at f₁ (351) provided by the modulator 231 (FIG. 2) an SRL signal appears at the frequency f₂ (352).

The device 200 also comprises second optical means configured for optical detection, at the Stokes angular frequency ω_{S}, of a second non-linear optical signal 207, the second optical signal resulting from the interaction of the light pulses in the sample.

In the same way, FIG. 3D illustrates, according to one example, the intensity I_{S} of the second non-linear optical signal 207 at the pump angular frequency ωₛ (curve 37), and curve 38 in FIG. 3D illustrates the power spectral density as a function of frequency for the optical signal 207. As may be seen in FIG. 3D, in addition to the modulation at f2 (362) provided by the modulator 232 (FIG. 2) an SRG signal appears at the frequency f₁ (361).

In the example of FIG. 2, the first and second optical detecting means share a collecting objective 254, which is for example arranged in the microscope body 250, and a set of reflective elements 264, 265, which includes a dichroic mirror 265 allowing the two detection channels to be split. The collecting objective 254 is for example a microscope objective of higher numerical aperture than the microscope objective 252, and for example of a numerical aperture NA=0.60, in order to collect the trains of pulses returned from the sample without the need for a diaphragm.

Moreover, the first optical detecting means comprise a first optical detector 271 and the second optical detecting means comprise a second optical detector 272. The first and second detectors 271, 272 are for example photodiodes that are sensitive at the pump and Stokes angular frequencies, respectively. Each detection channel may moreover comprise one or more optical conjugating elements and optical filtering means (not shown), an interference optical filter for example, allowing the radiation at the angular frequency of interest to be selected for each detector.

In the example of FIG. 2, the first and second optical detecting means are configured for a detection in forward configuration. Of course, it is entirely possible to envisage first and second optical detecting means configured for a detection in epi configuration, which is especially advantageous for thick/not very transparent samples. In this case, the collected signals depend on the back-scattering nature of the sample.

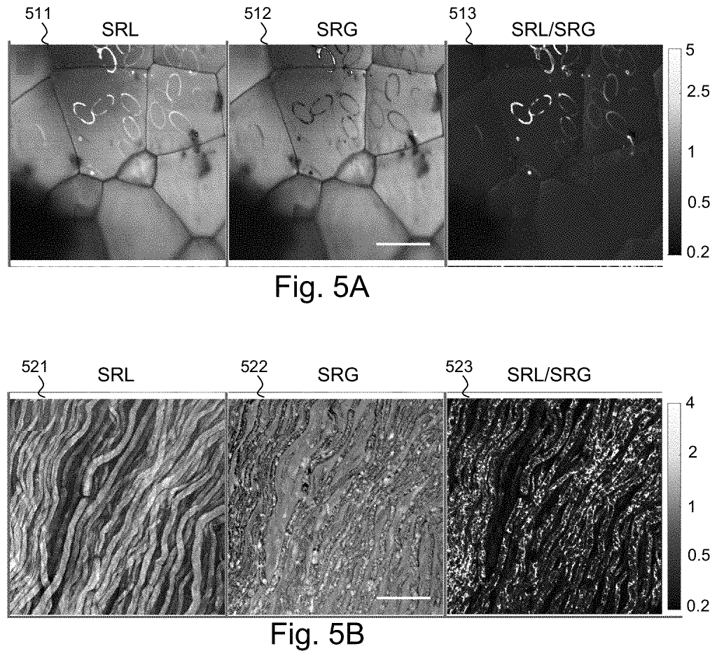

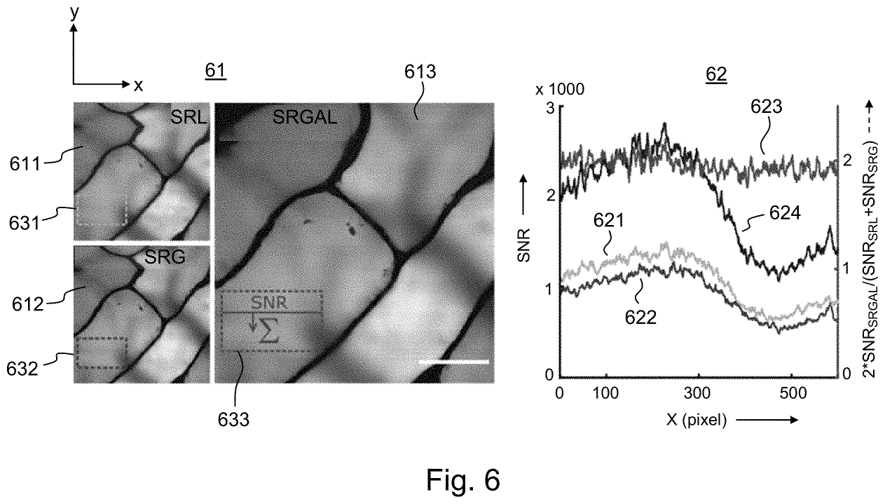

As illustrated in FIG. 2, the device 200 moreover comprises first means 281 of synchronous detection, allowing, at the second modulation frequency f₂, and from the first non-linear optical signal 206 detected by the first optical detector 271, a first signal 208 characteristic of the molecular vibrational resonance of the sample to be extracted. As will be explained in more detail below, the signal 208 is none other than the SRL signal. The device 200 also comprises second means 282 of synchronous detection, allowing, at the first modulation frequency f₁, and from the second non-linear optical signal 207 detected by the second detector 272, a second signal 209 characteristic of the molecular vibrational resonance of the sample to be extracted. As will be explained in more detail below, the signal 209 is the SRG signal. The device 200 lastly comprises electronic processing means 290 that are configured to compare the first signal characteristic of the molecular vibrational resonance of the sample S (SRL signal) and the second signal characteristic of the molecular vibrational resonance of the sample S (SRG signal) in order to determine whether artefacts are present, as will be illustrated by means of FIGS. 5A, 5B and 6.

The first and second means 281, 282 of synchronous detection may for example comprise an analogue synchronous detection at the modulation frequencies f₁, f₂, respectively.

Alternatively, the synchronous detection of the signal on each of the channels may be achieved digitally, via digital processing of the signals output directly from the detecting optics.

FIGS. 4A and 4B illustrate the synchronous detection of the first non-linear optical signal 206 and the synchronous detection of the second non-linear optical signal 207, respectively, at the frequency f₂ and at the frequency f₁, respectively.

In FIG. 4A, the schematic 41 illustrates the intensity as a function of time of the train of pulses 204 (FIG. 2) at the pump angular frequency ωₚ, this train being modulated at the first frequency f₁. The schematic 42 illustrates the intensity as a function of time of the first non-linear optical signal 206 detected by the first optical detector 271. As may be seen in the schematic 42, the intensity of the first non-linear optical signal 206 is decreased with respect to the optical signal 204. This decrease in intensity results from the SRL process on the train of pulses at the pump angular frequency, the process being induced by the interaction with the train of pulses at the Stokes angular frequency, which train is modulated at the frequency f₂. The synchronous detection at the second frequency f₂ thus allows the signal 208 (schematic 43), which is the SRL signal corresponding to the decrease in the intensity of the pump beam, to be extracted.

In the same way, in FIG. 4B, the schematic 44 illustrates the intensity as a function of time of the train of pulses 205 (FIG. 2) at the Stokes angular frequency ω_{S}, this train being modulated at the second frequency f₂. The schematic 45 illustrates the intensity as a function of time of the second non-linear optical signal 207 detected by the second non-linear optical detector 272. As may be seen in the schematic 45, the intensity of the second optical signal 207 is increased with respect to that of the optical signal 205. This increase in intensity results from the SRG process on the train of pulses at the Stokes angular frequency, the process being induced by the interaction with the train of pulses at the pump angular frequency, which train is modulated at the frequency f₁. The synchronous detection at the frequency f, thus allows the signal 209 (schematic 46), which is the SRG signal corresponding to the gain of Stokes-beam intensity, to be extracted.

The applicant has shown that comparison of these signals allows information to be obtained on artefacts.

Specifically, the amplitude of these SRL and SRG signals after calibration should be equal. A difference in amplitude is therefore indicative of an artefact in the measurement of the SRS signal.

FIGS. 5A, 5B and 6 illustrate the exploitation of the SRL and SRG signals determined by means of a method according to the present description, in the case of application to imaging.

The images of FIGS. 5A, 5B and 6 use a calibration comprising the determination of a spatial mean over all of the pixels of the image and the normalization of each image with the computed mean. Alternatively, it is possible to calibrate the device such that the gains of the SRL and SRG electronics give equal SRL and SRG signals for a test sample having a high SRS signal (for example oil at 2850 cm⁻¹).

More precisely, FIG. 5A shows experimental images representing a two-dimensional SRL signal (image 511), a two-dimensional SRG signal (image 512) and the ratio of the SRL/SRG signals (image 513) of the surface of an oyster shell. The SRL and SRG signals are obtained with an SRS microscope according to the present description, at the resonant frequency of phosphate (1090 cm⁻¹). It may be seen that the SRL/SRG ratio (513) has a value strictly higher than 1 on elliptical structures that are attributed to parasites and that exhibit 2-photon absorption (increase of the SRL signal in the image 511 and decrease of the SRG signal in the image 512). These elliptical structures are thus interpreted as being artefacts in the SRL (511) and SRG (512) images.

FIG. 5B shows experimental images representing a two-dimensional SRL signal (image 521), a two-dimensional SRG signal (image 522) and the ratio of the SRL/SRG signals (image 523) of mouse nerve cells. The SRL and SRG signals are obtained with an SRS microscope according to the present description, at the resonant frequency of the CH₂ bond (2850 cm⁻¹). It may be seen that the SRL/SRG ratio (523) has a value strictly higher than 1 on discrete structures that are interpreted as being local accumulations of myelin that produce cross phase modulation. These discrete structures are thus interpreted as being artefacts in the SRL (521) and SRG (522) images.

FIG. 6 shows, in the schematic 61, experimental images showing, in a coordinate system XY, a two-dimensional SRL signal (image 611) and a two-dimensional SRG signal (image 612) of the surface of an onion cell, and the sum SRL+SRG of the SRL and SRG signals (image 613), which is called the SRGAL signal in the present description. The SRL and SRG signals are obtained with an SRS microscope according to the present description, at the resonant frequency of the CH₂ bond (2850 cm⁻¹).

Moreover, FIG. 6 shows, in the schematic 62, curves representing signal-to-noise ratios (or SNRs) of the SRL (621), SRG (622) and SRL+SRG (624) images illustrated in the schematic 61, as a function of the direction X. These signal-to-noise ratios are the ratio between the squared mean of the signal and its variance. They are established in regions of interest of each image, which are indicated by the dashed rectangles 631, 632, 633 in the images 611, 612 and 613, respectively. They are integrated in the direction Y of the regions of interest and represented along X in the graph 62. It may be seen that the SNRs of the SRL (621) and SRG (622) images (denoted SNR_{SRL}, and SNR_{SRG}, respectively) are similar. In contrast, the SNR of the sum SRL+SRG (624) (denoted SNR_{SRGAL}) is higher by a factor 2. This is graphically illustrated by curve 623, which shows the ratio 2SNR_{SRGAL}/(SNR_{SRL}+SNR_{SRG}). This demonstrates that the image SRL+SRG (613) has an SNR two times higher than the SRL (611) and SRG (612) images.

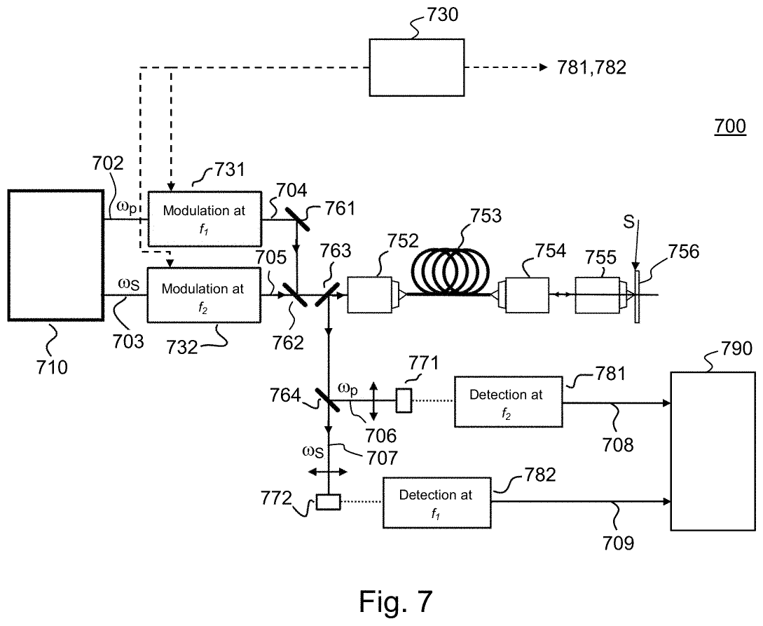

FIG. 7 shows a schematic of a device 700 for detecting a resonant non-linear optical signal of stimulated-Raman-scattering (SRS) type induced in a sample S, and more precisely a schematic illustrating an example of an SRS microscope according to the present description in an endoscopic mode using an optical fibre.

As described with reference to FIG. 2, the device 700 comprises a light source 710 that is configured to emit a first beam 702, or “pump beam”, formed from a first train of pump pulses at a first angular frequency ωₚ and that is configured to emit a second beam 703, or “Stokes beam”, formed from a second train of Stokes pulses at a second angular frequency ωₛ, these angular frequencies being such that a difference ωₚ−ωₛ between the first and second angular frequencies is equal to an angular frequency ΩR of molecular vibrational resonance of the sample S that it is sought to observe. The first train of pulses and the second train of pulses are temporally synchronized in order to allow the pump and Stokes pulses to interact in the sample and the light source 710 may be a source such as those described with reference to FIG. 2. A delay line (not shown in FIG. 7) may allow the trains of pump and Stokes pulses to be synchronized temporally in order to ensure a temporal overlap of the pulses in the sample. The delay line may also be configured to introduce a variable time delay. It may be positioned on either or both of the pump and Stokes channels. The device 700 comprises a first amplitude modulator 731 configured to amplitude modulate the first train of pump pulses at a first modulation frequency f₁ and a second amplitude modulator 732 configured to amplitude modulate the second train of Stokes pulses at a second modulation frequency f₂ different from the first modulation frequency. The amplitude modulators 731, 732 for example receive modulation signals from a radiofrequency (RF) generator 730. As a result, pump and Stokes beams formed from pulse trains that are amplitude modulated at the frequencies f₁ and f₂, and that are denoted 704 and 705 in FIG. 2, respectively, are produced. The frequencies f₁ and f₂ may be similar to those described with reference to FIG. 2.

In the example of FIG. 7, the device 700 further comprises optomechanical means for making interact in the sample S the amplitude-modulated trains of pump and Stokes pulses 704, 705.

The optomechanical means are configured in this example for an application to endoscopy. The optomechanical means thus comprise, in this example, a transporting optical fibre 753, a single-mode optical fibre for example, and optical elements for injecting trains of pump and Stokes pulses into the fibre 753. The optical elements for injecting into the fibre comprise, in this example, reflective elements 761, 762, 763, which for example include dichroic mirrors 761, 762 and a semi-reflective element 763, and a microscope objective 752. On exiting the fibre, the trains of pulses are collected by a microscope objective 754 and transmitted to a microscope objective 755 that is configured to focus the pump and Stokes pulses into a common focal volume in the sample S. The sample S may be scanned either by moving the latter using an XY translational stage (referenced 756) or, especially when the sample S is not accessible, by inserting a scanning device (not shown in FIG. 7) configured to scan the trains of pump and Stokes pulses over the sample. Such a scanning device may be similar to that shown in FIG. 2 or more compact, by virtue of the use for example of piezoelectric tubes arranged in the distal portion of the endoscope.

The example of FIG. 7 illustrates a device in “epi” configuration, in which:

The first and second optical detecting means are configured for the optical detection, at the pump angular frequency ωₚ, of a first non-linear optical signal (signal referenced 706 in FIG. 7) backscattered by the sample, and for the optical detection, at the Stokes angular frequency ω_{S}, of a second non-linear optical signal (signal referenced 707 in FIG. 7) backscattered by the sample, respectively, the two signals resulting from the interaction of the light pulses in the sample. Thus, the first and second optical detecting means comprise optical elements common to the optomechanical means in order to make interact in the sample S the pump and Stokes pulse trains, namely the microscope objectives 755, 754, 752 and the optical fibre 753. The backscattered pump and Stokes signals are thus collected by the same optical fibre 753 and redirected to a first optical detector 771 and to a second optical detector 772, respectively, by means of the semi-reflective plate 763 and a dichroic plate 764 allowing the signals 706 and 707 to be split. As with reference to FIG. 2, synchronous detections 781, 782 allow the SRL (708) and SRG (709) signals, respectively, to be extracted, which signals are processed by the processing means 790 with a view to implementing a method according to the present description, as for example described with reference to FIGS. 5A, 5B and 6.

Irrespectively of whether it is a question of the example of FIG. 2 or the example of FIG. 7, for an application of the device to spectroscopy or to hyperspectral imaging, it is also possible to make the angular frequencies ωₚ and/or ω_{S} of the trains of pump and Stokes pulses vary in order to probe the SRS signal as a function of molecular vibrational frequency. The processing means 290 (FIG. 2) or 790 (FIG. 7) thus allow the sought-after characteristic signal to be extracted as a function of molecular vibrational frequency in order to form a spectrum.

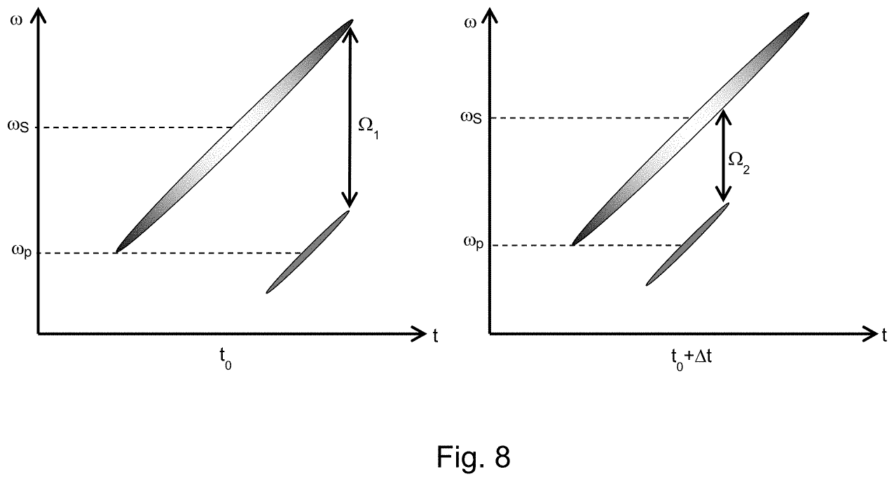

FIG. 8 illustrates a particular example in which the pump and Stokes pulses are ultrashort pulses that are temporally stretched by means of a stretcher in order to form trains of frequency-chirped pulses that are centred on the angular frequencies ωₚ and ω_{S}, respectively. A modulation of the time delay between the trains of pulses at the angular frequencies ωₚ and ω_{S} is then possible by means for example of a delay line, as was described with reference to FIG. 2 for example. The same synchronous-detection method may be implemented for the detection of the SRG and SRL signals. As illustrated in FIG. 8, a variation in the time delay Δt then allows the vibrational resonance of interest Ω to be probed.

Although described through a certain number of exemplary embodiments, the methods and devices according to the present description comprise various variants, modifications and improvements that will appear obvious to anyone skilled in the art, and it will be understood that these various variants, modifications and improvements form part of the scope of the invention such as defined by the following claims.

### REFERENCES

[Ref. 1] N. Bloembergen et al. “The stimulated Raman effect”, American Journal of Physics, 35, 989-1023, 1967)

[Ref. 2]: C. W. Freudiger et al. “Label free biomedical imaging with high sensitivity by stimulated Raman scattering microscopy”, Science, 322 (5909), 1857-1861, 2008

[Réf . 3] : Marshall T. Bremer et al. <<Standoff explosives trace detection and imaging by selective stimulated Raman scattering“, Applied Physics Letters, vol. 103, no. 6, 5 août 2013, page 061119.

[Ref. 4] WO2014154708

1. A device for detecting a resonant non-linear optical signal of stimulated-Raman-scattering type induced in a sample, the device comprising:
a light source configured for emitting a first train of pump pulses at a first angular frequency and a second train of Stokes pulses at a second angular frequency, the angular frequencies being such that a difference between the first and second angular frequencies is equal to an angular frequency of molecular vibrational resonance of the sample, the first and second trains of pulses being temporally synchronized;
a first amplitude modulator configured to amplitude modulate the first train of pump pulses at a first modulation frequency and a second amplitude modulator configured to amplitude modulate the second train of Stokes pulses at a second modulation frequency different from the first modulation frequency;
optomechanical means for making interact in the sample said amplitude-modulated trains of pump and Stokes pulses;
first optical detecting means configured for optical detection of a first non-linear optical signal at said first angular frequency, said first non-linear optical signal resulting from the interaction, in the sample, of the amplitude modulated pump and Stokes light pulses in the sample, and means of synchronous detection at said second modulation frequency, allowing a first signal characteristic of the molecular vibrational resonance of the sample to be extracted from the first non-linear optical signal thus detected;
second optical detecting means configured for optical detection of a second non-linear optical signal at said second angular frequency, said second optical signal resulting from the interaction, in the sample, of the amplitude modulated pump and Stokes light pulses in the sample, and means of synchronous detection at said first modulation frequency, allowing a second signal characteristic of the molecular vibrational resonance of the sample to be extracted from the second optical signal thus detected;
electronic processing means configured to compare said first and second signals characteristic of the molecular vibrational resonance of the sample in order to determine the presence of artefacts.

2. The device according to claim 1, wherein the comparison of said first and second signals characteristic of the molecular vibrational resonance of the sample comprises the computation of a ratio between said signals.

3. The device according to claim 1, wherein said electronic processing means are configured to further compute a sum and/or a difference of said first and second signals characteristic of the molecular vibrational resonance of the sample.

4. The device according to claim 1, wherein said optomechanical means comprise an optical element for focusing the trains of pulses into a common focal volume.

5. The device according to claim 4, wherein said optomechanical means further comprise means for moving relatively the focal volume in the sample.

6. The device according to claim 1, wherein the first and second trains of pulses are trains of frequency-chirped pulses centred on the first and second angular frequencies, respectively.

7. The device according to claim 6, further comprising a delay line configured to generate a time shift between the pulses of the first train of pulses and the pulses of the second train of pulses, such as to make vary the frequency of molecular vibrational resonance of the sample at which the non-linear optical signal is detected.

8. The device according to claim 1, characterized in that it is at least partially fibre-based.

9. A method for detecting a resonant non-linear optical signal of stimulated-Raman-scattering type induced in a sample, comprising:
the emission of a first train of pump pulses at a first angular frequency and a second train of Stokes pulses at a second angular frequency, the angular frequencies being such that a difference between the first and second angular frequencies is equal to an angular frequency of molecular vibrational resonance of the sample, the first and second trains of pulses being temporally synchronized;
the amplitude modulation of said first train of pump pulses and said second train of Stokes pulses at a first modulation frequency and at a second modulation frequency different from the first modulation frequency, respectively;
the interaction in the sample of said amplitude-modulated trains of pump and Stokes pulses;
a first optical detection of a first non-linear optical signal at said first angular frequency, said first non-linear optical signal resulting from the interaction of the light pulses in the sample, and a first synchronous detection at said second modulation frequency, allowing a first signal characteristic of the molecular vibrational resonance of the sample to be extracted from the first non-linear optical signal thus detected;
a second optical detection of a second non-linear optical signal at said second angular frequency, said second non-linear optical signal resulting from the interaction of the light pulses in the sample, and a second synchronous detection at said first modulation frequency, allowing a second signal characteristic of the molecular vibrational resonance of the sample to be extracted from the second non-linear optical signal thus detected;
a comparison of said first and second signals characteristic of the molecular vibrational resonance of the sample in order to determine the presence of artefacts.

10. The method according to claim 9, wherein said comparison of said first and second signals characteristic of the molecular vibrational resonance of the sample comprises the computation of a ratio between said two signals.

11. The method according to claim 9, further comprising the computation of a sum of said two signals characteristic of the molecular vibrational resonance of the sample, the resultant signal being doubled and at least partially freed from said artefacts.

12. The method according to claim 9, further comprising the computation of a difference of said two signals characteristic of the molecular vibrational resonance of the sample, the resultant signal being representative of at least some of said artefacts.

13. The method according to claim 9, wherein the first and second trains of pulses are trains of frequency-chirped pulses centred on the first and second angular frequencies, respectively.

14. The method according to claim 13, further comprising the generation of a time shift between the pulses of the first train of pulses and the pulses of the second train of pulses, such as to make vary the frequency of molecular vibrational resonance of the sample at which the non-linear optical signal is detected.

15. The method according to claim 9 applied to Raman vibrational imaging, wherein the interaction in the sample of said amplitude-modulated trains of pump and Stokes pulses comprises focusing the trains of pulses into a common focal volume and a relative movement of the focal volume in the sample, the first and second signals characteristic of the molecular vibrational resonance of the sample being two-dimensional signals.
